(19) United States
(12) Patent Application Publication
(10) Pub. No.: US 2015/0215156 A1
(43) Pub. Date: Jul. 30, 2015

(54) METHOD AND APPARATUS FOR NETWORK FAILURE RESTORATION

(71) Applicant: Electronics and Telecommunications Research Institute, Daejeon (KR)

(72) Inventor: Bin Yeong YOON, Daejeon (KR)

(21) Appl. No.: 14/600,892

(22) Filed: Jan. 20, 2015

(30) Foreign Application Priority Data
Jan. 24, 2014 (KR) 10-2014-0009034

(51) Int. Cl. H04L 12/24; H04L 12/703; H04L 12/26

(52) U.S. Cl. CPC H04L 41/0654; H04L 43/0823; H04L 45/28

(57) ABSTRACT

Provided are a method and an apparatus for performing network failure restoration when a failure occurs in a software-defined networking (SDN) network, the method including detecting a failure by verifying whether a failure occurs in a channel and switching a channel from a first channel to a second channel when a failure occurs and thus, recovering from the failure by switching the channel from the first channel to the second channel.

### CROSS-REFERENCE TO RELATED APPLICATION

This application claims the priority benefit of Korean Patent Application No. 10-2014-0009034, filed on Jan. 24, 2014, in the Korean Intellectual Property Office, the disclosure of which is incorporated herein by reference.

### BACKGROUND

1. Field of the Invention

Embodiments of the present invention relate to a method and an apparatus for network failure restoration, and more particularly, to a method and an apparatus for network failure restoration in a software-defined networking (SDN) network.

2. Description of the Related Art

In a data network, devices such as a router and a switch may include a controller and a data processor. When a failure occurs in the network, the controller may rapidly switch a channel through duplexing and thus, improve reliability of the network.

In a software-defined networking (SDN) network, a controller and a data processor may be decoupled to set the SDN. The controller of the SDN may simultaneously control a plurality of data processors. The controller and the data processors may be connected through the network.

However, when a failure occurs in any one of the controller and the data processors, a packet passing through the data processors may not be transmitted.

### SUMMARY

An aspect of the present invention provides a method and an apparatus for network failure restoration.

Another aspect of the present invention also provides a method and an apparatus for network failure restoration in a software-defined networking (SDN) network.

According to an aspect of the present invention, there is provided a method of performing network failure restoration including verifying whether a failure occurs in a first channel connecting a first SDN controller of the SDN and a device and switching a channel from the first channel to a second channel when the failure is detected by the verifying. The first SDN controller may set a path through which a packet is transmitted through at least one device including the device in the SDN.

The second channel may refer to an auxiliary channel to connect the first SDN controller and the device.

The method may further include transmitting control information on the at least one device from the first SDN controller to a second SDN controller of the SDN.

The control information may refer to information on the at least one device used to set the path.

The verifying may include receiving a monitoring message from the device through the first channel.

When the device does not receive a reply to the monitoring message, the verifying may include detecting a failure of the first channel.

When the failure of the first channel is detected, the switching of the channel may be performed from the first channel to the second channel by the device.

When the switching of the channel is performed, the method may further include receiving information on the switching of the channel by an administrator from the device.

The administrator may be connected to the first SDN controller and the device.

The method may further include the administrator setting a third channel to connect the first SDN controller and the device.

When a failure of the second channel is detected, the third channel may be used to recover from the failure of the second channel.

The method may further include transmitting the control information on the at least one device from the first SDN controller to the second SDN controller of the SDN.

The second channel may refer to a channel to connect the second SDN controller and the device.

The control information may refer to information on the at least one device used to set the path.

The verifying may include receiving a monitoring message from the device through the first channel.

When the device does not receive a reply to the monitoring message, the verifying may further include determining whether a failure occurs in the first channel.

When the failure does not occur in the first channel, the switching of the channel may be performed.

The switching of the channel may include the administrator determining whether an SDN controller of the SDN in a standby mode is present.

When the second SDN controller is present in the standby mode, the switching of the channel may further include activating the second SDN controller by the administrator.

The administrator may be connected to the first SDN controller, the second SDN controller, and the device.

When the failure is not detected in the first channel and the administrator receives failure messages from at least two among the at least one device, the verifying may further include the administrator determining that a failure occurs in the first SDN controller.

The administrator may be connected to the first SDN controller, the second SDN controller, and each of the at least one device.

The verifying may include transmitting a monitoring message from the administrator to the first SDN controller.

When the administrator does not receive a reply to the monitoring message from the first SDN controller, the verifying may further include determining that the failure occurs in the first SDN controller.

When the failure is determined to occur from the first SDN controller, the switching of the channel may be performed from the first channel to the second channel.

The administrator may be connected to the first SDN controller, the second SDN controller, and each of the at least one device.

The method may further include transmitting the control information on the at least one device from the first SDN controller to a backup database.

The method may further include storing the control information in the backup database.

The control information may refer to information on the at least one device used to set the path.

When a failure is detected, the method may further include transmitting the control information from the backup database to the second SDN controller of the SDN.

The second channel may refer to a channel to connect the second SDN controller and the device.

The verifying may include receiving a monitoring message from the device through the first channel.

When the device does not receive a reply to the monitoring message, the verifying may further include determining whether the failure occurs in the first channel.

When a failure is detected in the first channel, the switching of the channel may be performed from the first channel to the second channel that is an auxiliary channel to connect the first SDN controller and the device.

When a failure is not detected in the first channel and failure messages are received from at least two among the at least one device, the verifying may further include determining that the failure occurs in the first SDN controller by the administrator.

The administrator may be connected to the first SDN controller, the backup database, and each of the at least one device.

The switching of the channel may include setting the second SDN controller of the SDN by the administrator.

The switching of the channel may further include transmitting the control information from the backup database to the second SDN controller.

The switching of the channel may further include the administrator activating the second SDN controller.

The second channel may refer to a channel to connect the second SDN controller and the device.

When the second SDN controller is activated, the switching of the channel may be performed from the first channel to the second channel.

The verifying may include transmitting a monitoring message from the administrator to the first SDN controller.

When the administrator does not receive a reply to the monitoring message from the first SDN controller, the verifying may include determining that the failure occurs in the first SDN controller.

The switching of the channel may include the administrator setting the second SDN controller of the SDN.

The switching of the channel may further include transmitting the control information from the backup database to the second SDN controller.

The switching of the channel may further include the administrator activating the second SDN controller.

The second channel may refer to a channel to connect the second SDN controller and the device.

When the second SDN controller is activated, the switching of the channel may be performed from the first channel to the second channel.

According to another aspect of the present invention, there is provided an apparatus for performing network failure restoration including a first SDN controller to set a path through which a packet is transmitted using at least one device to transmit the packet in SDN and an administrator to set the first SDN controller of the SDN and the at least one device. The first SDN controller and a device may be connected through a first channel. When a failure is detected in the connection, a channel may be switched from the first channel to a second channel. The at least one device including the device may transmit the packet through the set path.

According to still another aspect of the present invention, there is provided a method of performing network failure restoration including transmitting a monitoring message from a software-defined networking (SDN) controller to a device through a first channel connecting the SDN controller and the device, determining whether a failure occurs in the first channel when the SDN controller does not receive a reply to the monitoring message from the device, and setting a second path to provide a detour around the device to transmit a packet by the SDN controller when a failure does not occur in the first channel. At least one device including the device may transmit the packet through the first channel set by the SDN controller to transmit the packet. The packet may be transmitted through the second path.

When a failure does not occur in the first channel, the method may further include transmitting information on the failure from the SDN controller to an administrator.

The method may further include the administrator detecting a failure occurring in the device.

The method may further include the administrator requesting the SDN controller to set the second path.

The setting of the second path may be performed by the SDN controller based on the requesting.

The administrator may be connected to the first SDN controller and each of the at least one device.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a software-defined networking (SDN) providing system according to an embodiment of the present invention;

FIG. 2 is a diagram illustrating a configuration of a system for performing network failure restoration using an auxiliary channel according to an embodiment of the present invention;

FIG. 3 is a signal flowchart illustrating a method of performing network failure restoration using an auxiliary channel according to an embodiment of the present invention;

FIG. 4 is a diagram illustrating a configuration of a system for performing network failure restoration using an SDN controller in a standby mode according to an embodiment of the present invention;

FIG. 5 is a diagram illustrating a configuration of a system for performing network failure restoration by activating an SDN controller in a standby mode according to an embodiment of the present invention;

FIG. 6 is a signal flowchart illustrating a method of performing network failure restoration using an SDN controller in a standby mode according to an embodiment of the present invention;

FIG. 7 is a signal flowchart illustrating a method of performing network failure restoration by an administrator according to an embodiment of the present invention;

FIG. 8 is a diagram illustrating a configuration of a system for performing network failure restoration using a backup database according to an embodiment of the present invention;

FIG. 9 is a diagram illustrating a configuration of a system for performing network failure restoration using a backup database according to another embodiment of the present invention;

FIG. 10 is a signal flowchart illustrating a method of performing network failure restoration using a backup database according to an embodiment of the present invention;

FIG. 11 is a signal flowchart illustrating a method of performing network failure restoration by an administrator according to another embodiment of the present invention;

FIG. 12 is a diagram illustrating a configuration of a system for performing network failure restoration by changing a path through which a packet is transmitted according to an embodiment of the present invention; and

FIG. 13 is a signal flowchart illustrating a method of performing network failure restoration by changing a path through which a packet is transmitted according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

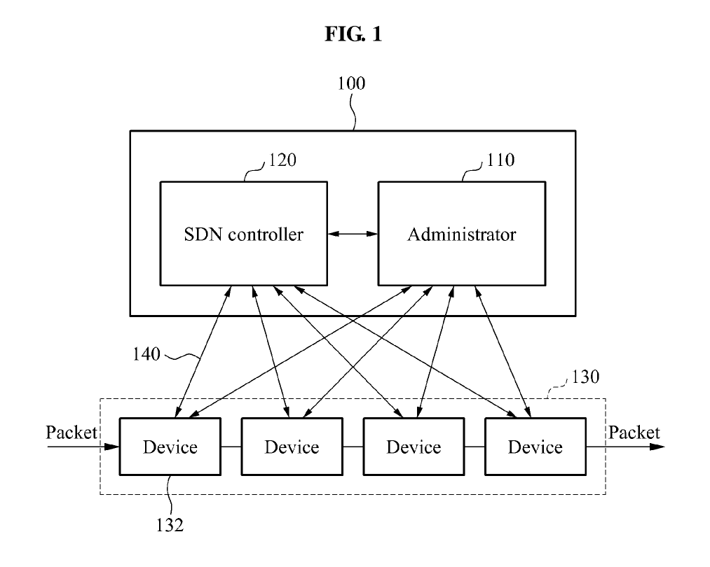

FIG. 1 is a diagram illustrating a configuration of a software-defined networking (SDN) providing system according to an embodiment of the present invention.

An SDN providing apparatus may include a controller to control a processor. For example, the processor may be one of a router, a switch, and a node.

The controller may control at least one processor simultaneously. For example, the controller may control the at least one processor by applying a centralized method.

Referring to FIG. 1, the SDN providing system may provide the SDN. The SDN providing system may include an SDN providing apparatus 100 and at least one device 130.

The SDN providing apparatus 100 may include an administrator 110 and an SDN controller 120.

Also, the SDN providing apparatus 100 may additionally include the at least one device 130. For example, the at least one device 130 may be any one of a router, a switch, and a node.

The administrator 110 may be connected to the at least one device 130. For example, the administrator 110 may be connected to a device 132 of the at least one device 130 through a network.

The administrator 110 may initially set the SDN controller 120 and the at least one device 130 to provide the SDN. The administrator 110 may set respective states of the set

SDN controller 120 and the at least one device 130.

For example, the administrator 110 may set the SDN controller 120 and the at least one device 130 to transmit a packet.

The SDN controller 120 may be connected to each of the at least one device 130. For example, the SDN controller 120 and the device 132 may be connected through the network. The SDN controller 120 and the device 132 may be connected through a channel.

The SDN controller 120 and the device 132 may be connected based on an OpenFlow protocol.

The SDN controller 120 may set a path through which the packet is transmitted through the at least one device 130 in an SDN network.

The at least one device 130 may transmit the packet through the set path.

The administrator 110 may be connected to the SDN controller 120. The administrator 110 may control the SDN controller 120 through the connection.

The administrator 110 may be connected to each of the at least one device 130. The administrator 110 may control each of the at least one device 130 through the connection.

When a failure occurs in the SDN controller 120 or at least one among the at least one device 130, a network service may not be provided. Also, when a failure occurs in a channel between the SDN controller 120 and one among the at least one device 130, the network service may not be provided. For example, when a failure occurs in the channel between the SDN controller 120 and the device 132, the network service may not be provided.

When a failure occurs, a path of a packet passing through the device 132 may not be controlled. Accordingly, network failure restoration may be performed for normal transmission of the packet.

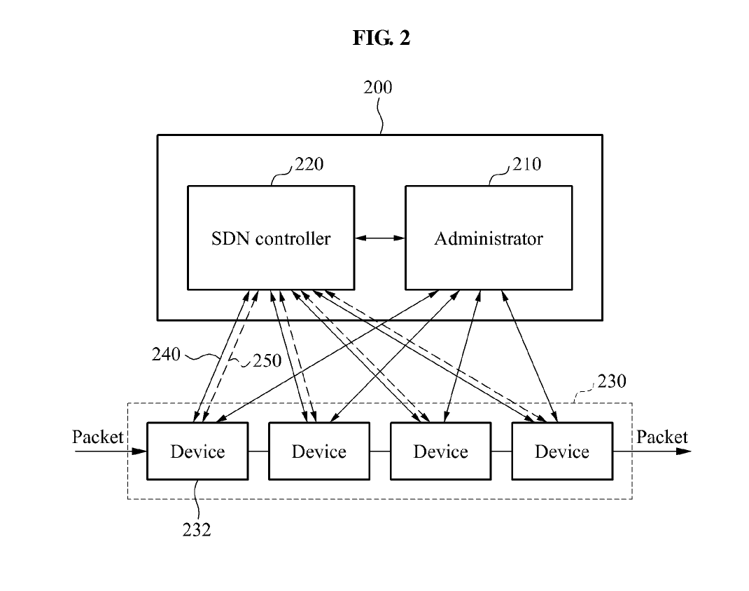

The method of performing network failure restoration will be further described with reference to FIGS. 2 through 13.

FIG. 2 is a diagram illustrating a configuration of a system for performing network failure restoration using an auxiliary channel according to an embodiment of the present invention.

Referring to FIG. 2, the system may include an apparatus 200 for performing network failure restoration and at least one device 230.

The apparatus 200 may include an administrator 210 and an SDN controller 220.

The apparatus 200 may additionally include the at least one device 230.

The system may provide an SDN. For example, the apparatus 200 may perform functions of the SDN providing apparatus 100 of FIG. 1. The administrator 210 may correspond to the administrator 110 of FIG. 1. The SDN controller 220 may correspond to the SDN controller 120 of FIG. 1.

The at least one device 230 may correspond to the at least one device 130 of FIG. 1.

The apparatus 200 may restore a network from a failure occurring in the network.

The SDN controller 220 may be connected to the at least one device 230 through a channel. For example, the SDN controller 220 may be connected to a device 232 through a first channel 240.

Also, the SDN controller 220 may be connected to the at least one device 230 through an auxiliary channel. For example, the SDN controller 220 may be connected to the device 232 through a second channel 250.

When a failure occurs in the first channel 240, the SDN controller 220 and the device 232 may be connected through the second channel 250.

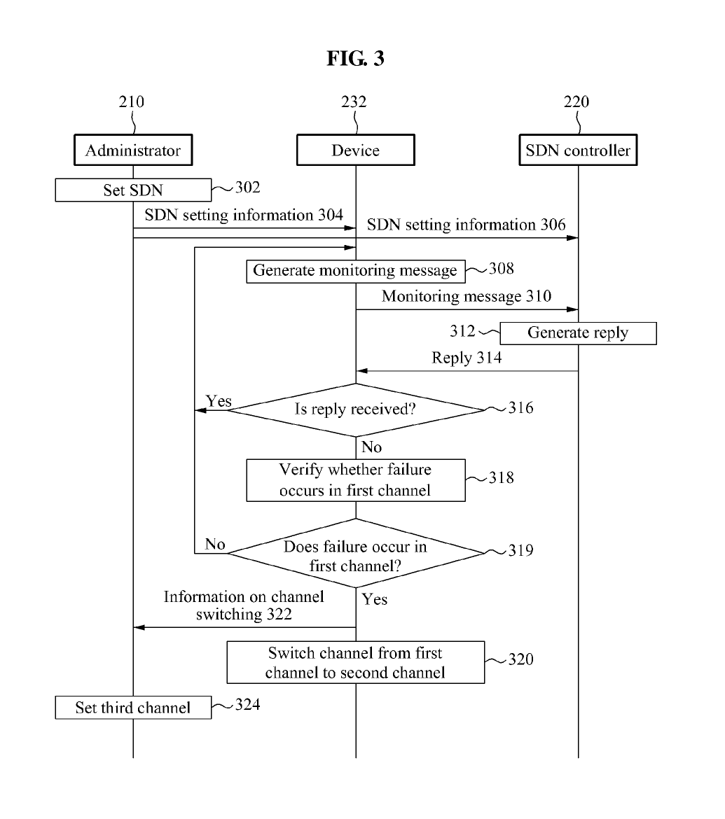

A method of performing network failure restoration when a failure occurs in the first channel 240 will be further described with reference to FIG. 3.

Technical descriptions provided with reference to FIG. 1 may be identically applied hereto and thus, a more detailed and repeated description will be omitted here for brevity.

FIG. 3 is a signal flowchart illustrating a method of performing network failure restoration using an auxiliary channel according to an embodiment of the present invention.

In operation 302, the administrator 210 may set SDN to transmit a packet. For example, the administrator 210 may set the SDN controller 220 that provides the SDN and the at least one device 230 of FIG. 2.

In operation 304, the administrator 210 may transmit information on the setting of the SDN, hereinafter referred to as SDN setting information, to the device 232 to be set. For example, the SDN setting information may include information on the administrator 210, the SDN controller 220 to be set, and the at least one device 230 to be set.

In operation 306, the administrator 210 may transmit the SDN setting information to the set SDN controller 220.

Operation 306 may be performed prior to or simultaneously with operation 304.

In operation 308, the device 232 may generate a monitoring message to detect a failure in the first channel 240 of FIG. 2. The device 232 may generate the monitoring message at a predetermined periodic interval.

In operation 310, the device 232 may transmit the generated monitoring message to the SDN controller 220 through the first channel 240.

In operation 312, the SDN controller 220 may generate a reply to the received monitoring message.

For example, the reply may include at least one of information on a point in time at which the monitoring message is received, information on a point in time at which the reply is generated, and information on a state of the first channel 240.

In operation 314, the SDN controller 220 may transmit the generated reply to the device 232 through the first channel 240.

In operation 316, the device 232 may determine whether the reply is received from the SDN controller 220.

For example, the device 232 may determine that the reply is not received when a period of time elapses from a point in time at which the monitoring message is transmitted without receipt of the reply.

When the reply is received in operation 316, operation 308 may be re-performed.

When the reply is not received in operation 316, operation 318 may be performed.

In operation 318, the device 232 may scan the first channel 240 to verify whether a failure occurs in the first channel 240 when the reply is not received in response to the monitoring message.

In operation 319, the device 232 may determine whether the failure occurs in the first channel 240.

When a failure is detected in the first channel 240, or a failure occurs in the first channel 240, operation 320 may be performed.

When a failure is not detected in the first channel 240, or a failure does not occur in the first channel 240, operation 308 may be re-performed.

Operations 308 through 319 may be performed to detect a failure in the first channel 240 that connects the SDN controller 220 and the device 232.

In operation 320, the device 232 may switch a channel from the first channel 240 to the second channel 250 when a failure is detected in the first channel 240. When a failure is detected in the first channel 240 by scanning the first channel 240, the device 232 may switch from the first channel 240 to the second channel 250.

The second channel 250 may be a channel connecting the device 232 and the SDN controller 220.

In operation 322, the device 232 may transmit information on the switching to the administrator 210.

In operation 324, the administrator 210 may set a third channel, an auxiliary channel for the second channel 250 that connects the SDN controller 220 and the device 232.

The third channel may be used to recover from a failure of the second channel 250 when the failure is detected in the second channel 250.

Technical descriptions provided with reference to FIGS. 1 and 2 may be identically applied hereto and thus, a more detailed and repeated description will be omitted here for brevity.

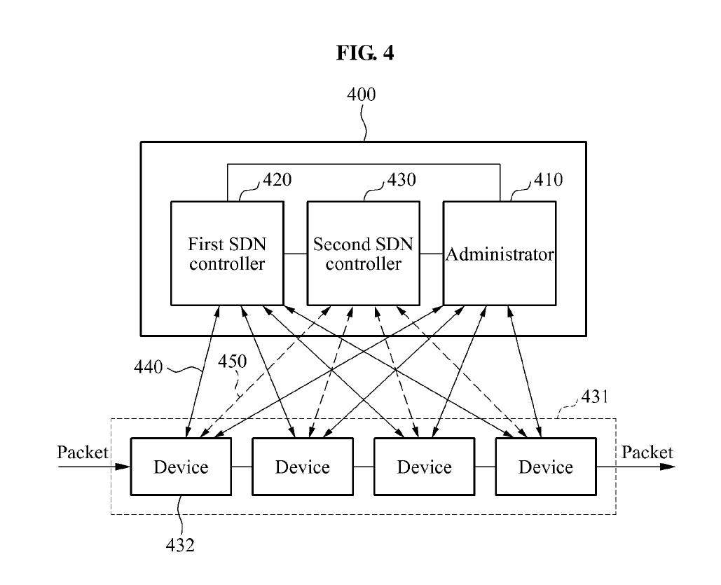

FIG. 4 is a diagram illustrating a configuration of a system for performing network failure restoration using an SDN controller in a standby mode according to an embodiment of the present invention.

Referring to FIG. 4, the system may include an apparatus 400 for performing network failure restoration and at least one device 431.

The apparatus 400 may include an administrator 410, a first SDN controller 420, and a second SDN controller 430.

Also, the apparatus 400 may additionally include the at least one device 431.

The first SDN controller 420 may be an activated SDN controller of an SDN.

The second SDN controller 430 may be the SDN controller in the standby mode of the SDN, namely, an inactivated SDN controller.

The system may provide the SDN.

The apparatus 400 may perform network failure restoration. For example, the apparatus 400 may perform functions of the apparatus 200 of FIG. 2. The administrator 410 may correspond to the administrator 210 of FIG. 2. The first SDN controller 420 and the second SDN controller 430 may correspond to the SDN controller 220 of FIG. 2.

The at least one device 431 may correspond to the at least one device 230 of FIG. 2.

The administrator 410 may be connected to the second SDN controller 430.

The first SDN controller 420 may be connected to the at least one device 431. For example, a first channel 440 may be a channel to connect the first SDN controller 420 and a device 432.

Also, the first SDN controller 420 may be connected to the at least one channel 431 through an auxiliary channel other than the channel.

The second SDN controller 430 may be connected to the at least one channel 431 through a channel. For example, a second channel 450 may be a channel to connect the second SDN controller 430 and the device 432.

When a failure occurs in the connection between the first SDN controller 420 and the device 432, the second SDN controller 430 and the device 432 may be connected through the second channel 250.

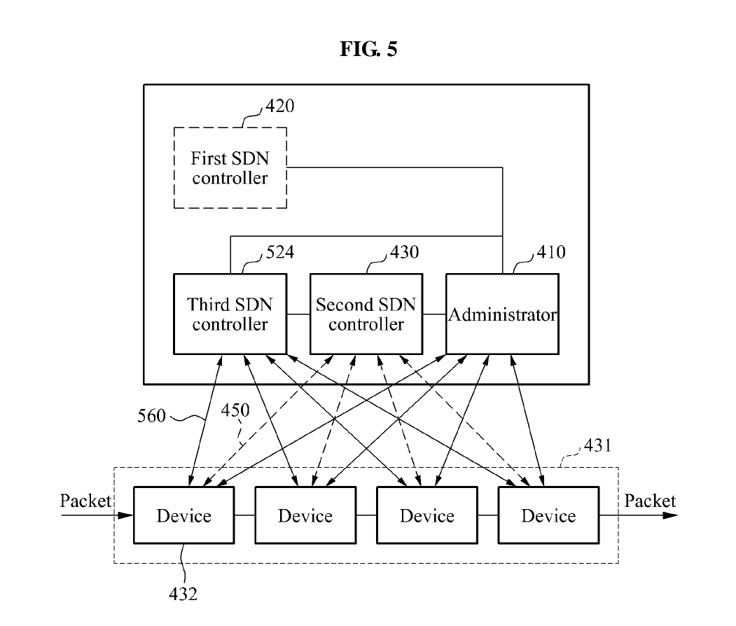

FIG. 5 illustrates a system for performing network failure restoration by activating the second SDN controller 430 in the standby mode when a failure occurs in the connection between the first SDN controller 420 and the device 432.

Technical descriptions provided with reference to FIGS. 1 through 3 may be identically applied hereto and thus, a more detailed and repeated description will be omitted here for brevity.

FIG. 5 is a diagram illustrating a configuration of a system for performing network failure restoration by activating an SDN controller in a standby mode according to an embodiment of the present invention.

Referring to FIG. 5, the second controller 430 may be an activated SDN controller to perform network failure restoration.

When a failure occurs in the connection between the first SDN controller 420 and the device 432, the administrator 410 may restore a network from the failure by changing an activated SDN controller of the SDN from the first SDN controller 420 to the second SDN controller 430.

When a failure occurs in the SDN controller 420, the first SDN controller 420 may be excluded from the SDN for transmitting a packet.

The administrator 410 may set a third SDN controller 524. The third SDN controller 524 may be an SDN controller in the standby mode.

When a failure occurs in the connection between the second SDN controller 430 and the device 432, the administrator 410 may restore the network from the failure by changing an activated SDN controller from the second SDN controller 430 to the third SDN controller 524 by setting the third SDN controller 524.

The third SDN controller 524 may be connected to the at least one device 431 through a channel. For example, the third SDN controller 524 may be connected to the device 432 through a third channel 560.

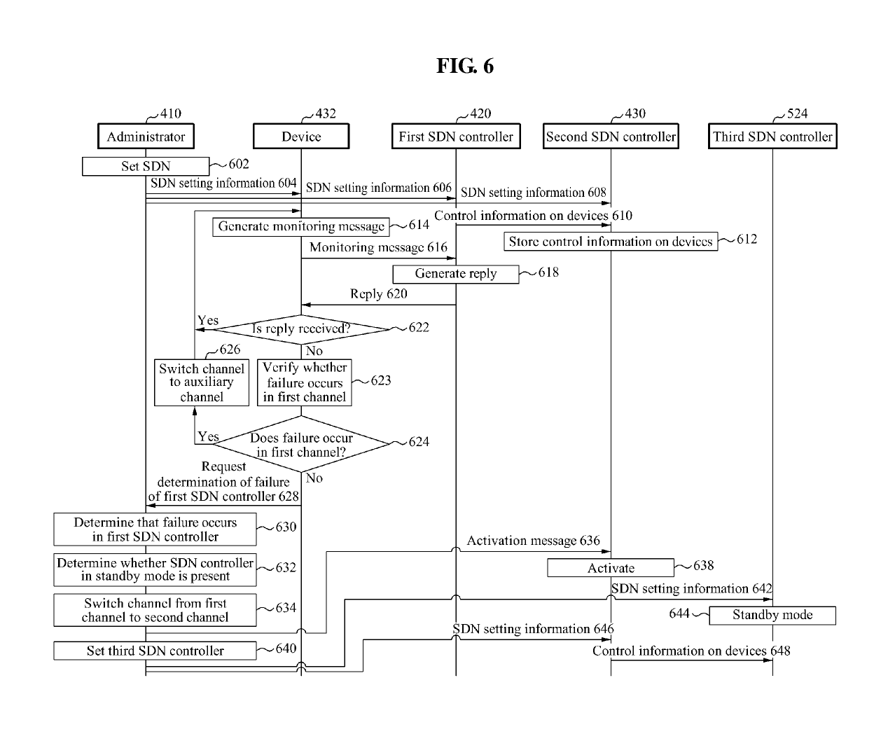

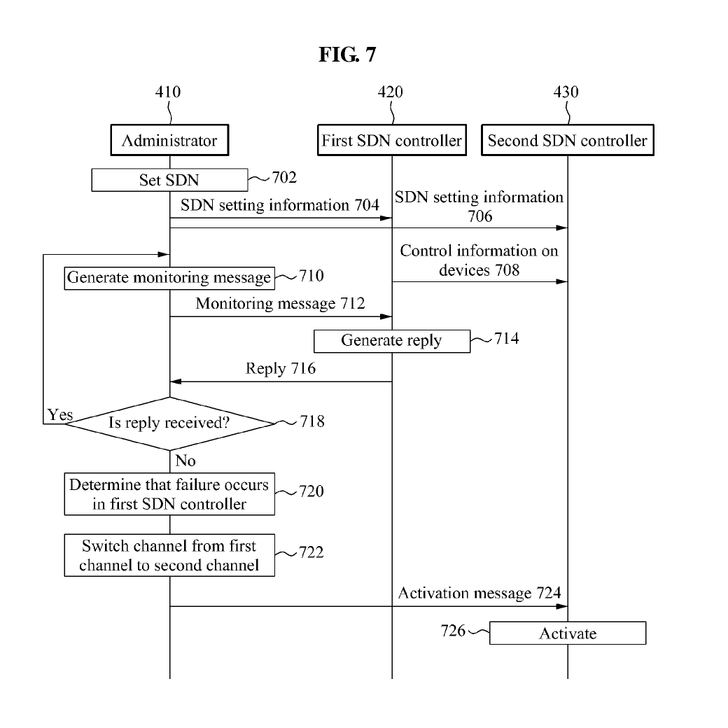

A method of performing network failure restoration using an SDN controller in the standby mode described with reference to FIGS. 4 and 5 will be further described with reference to FIGS. 6 and 7.

Technical descriptions provided with reference to FIGS. 1 through 4 may be identically applied hereto and thus, a more detailed and repeated description will be omitted here for brevity.

FIG. 6 is a signal flowchart illustrating a method of performing network failure restoration using an SDN controller in a standby mode according to an embodiment of the present invention.

In operation 602, the administrator 410 may set an SDN to transmit a packet. For example, the administrator 410 may set the first SDN controller 420 and the second SDN controller 430 of the SDN, and the at least one device 431.

In operations 604 through 608, the administrator 410 may transmit SDN setting information to the device 432 to be set and the first SDN controller 420 and the second SDN controller 430 to be set.

In operation 610, the first SDN controller 420 may transmit control information on the at least one device 431 to the second SDN controller 430. For example, the first SDN controller 420 may transmit control information on the device 432 to the second SDN controller 430.

The control information may include at least one of information on a path through which the packet is transmitted and information on the at least one device 431 used for the path through which the packet is transmitted.

Operations 614 through 624 may correspond to operations 308 through 319 described with reference to FIG. 3, respectively, and thus, respective descriptions of operations 614 through 624 may be replaced with descriptions of operations 308 through 319.

In operation 624, the device 432 may determine whether a failure occurs in the first channel 440 when the device 432 does not receive a reply from the first SDN controller 420 in response to a monitoring message.

When a failure is detected in the first channel 440, or a failure occurs in the first channel 440, operation 626 may be performed.

When a failure is not detected in the first channel 440, or a failure does not occur in the first channel 440, operation 628 may be performed.

In operation 626, the device 432 may switch a channel from the first channel 440 to an auxiliary channel when a failure is detected in the first channel 440. The auxiliary channel may be a channel connecting the first SDN controller 420 and the device 432.

Operation 614 may be re-performed subsequent to operation 626.

In operation 628, the device 432 may request the administrator 410 to determine whether a failure occurs in the first SDN controller 420. The device 432 may transmit a request for the determination of the failure of the first SDN controller 420 to the administrator 410.

The request for the determination of the failure of the first SDN controller 420 may refer to a failure message. For example, the device 432 may transmit the failure message with respect to the first SDN controller 420 to the administrator 410.

In operation 630, the administrator 410 may determine that a failure occurs in the first SDN controller 420. The administrator 410 may detect the failure of the first SDN controller 420.

The administrator 410 may receive at least one request for the determination of the failure of the first SDN controller 420 from the at least one device 431.

The administrator 410 may determine that the failure occurs in the first SDN controller 420 based on the at least one request received from the at least one device 431.

For example, when a failure is not detected in the first channel 440 and the administrator 410 receives failure messages from at least two among the at least one device 431 connected to the first SDN controller 420, the administrator 410 may determine that the failure occurs in the first SDN controller 420.

In operations 614 through 630, the first channel 440 that connects the first SDN controller 420 of the SDN and the device 432 may be scanned to verify whether a failure occurs in the first channel 440.

In operation 632, the administrator 410 may determine whether an SDN controller in a standby mode is present. The second SDN controller 430 may be the SDN controller in the standby mode.

In operation 634, the administrator 410 may switch a channel from the first channel 440 to the second channel 450 when a failure is detected. The second channel 450 may be a channel between the second SDN controller 430 and the device 432.

For example, when a failure occurs in the first SDN controller 420, the administrator 410 may switch the channel from the first channel 440 to the second channel 450.

In operation 636, the administrator 410 may transmit an activation message to the second SDN controller 430 to activate the second SDN controller 430 in the standby mode.

In operation 638, the second SDN controller 430 may be activated based on the activation message. The administrator 410 may activate the second SDN controller 430.

The activated second SDN controller 430 may transmit a packet based on stored control information.

According to an embodiment, operation 634 may be performed subsequent to operations 636 and 638. For example, in operation 634, the administrator 410 may switch the channel from the first channel 440 to the second channel 450 when the second SDN controller 430 is activated.

In operation 640, the administrator 410 may additionally set the third SDN controller 524 when the channel is switched from the first channel 440 to the second channel 450. The third SDN controller 524 to be set may be an SDN controller in the standby mode.

When a failure occurs in the second SDN controller 460, the third SDN controller 524 in the standby mode may be activated.

In operation 642, the administrator 410 may transmit SDN setting information to the third SDN controller 524.

In operation 644, the third SDN controller 524 may be set to be the standby mode.

In operation 646, the administrator 410 may transmit changed SDN setting information to the second SDN controller 430.

In operation 648, the second SDN controller 430 may transmit control information on the at least one device 431 to the third SDN controller 524 based on the received SDN setting information.

Referring to operations 614 through 638, the method of performing network failure restoration may be performed by detecting a failure in the connection between the first SDN controller 420 and the device 432 using a monitoring message by the device 432.

Also, the network failure restoration may be performed by detecting a failure in the connection between the first SDN controller 420 and the device 432 using the monitoring message from the administrator 410.

The method of performing network failure restoration by detecting a failure in the connection between the first SDN controller 420 and the device 432 using the monitoring message from the administrator 410 will be further described with reference to FIG. 7.

Technical descriptions provided with reference to FIGS. 1 through 5 may be identically applied hereto and thus, a more detailed and repeated description will be omitted here for brevity.

FIG. 7 is a signal flowchart illustrating a method of performing network failure restoration by the administrator 410 according to an embodiment of the present invention.

Operations 702 through 706 may correspond to operations 602, 604, and 608.

In operation 708, the first SDN controller 420 may transmit control information on the at least one device 431 to the second SDN controller 430.

In operation 710, the administrator 410 may generate a monitoring message to detect a failure in the connection between the first SDN controller 420 and the device 432. The administrator 410 may generate the monitoring message at a predetermined periodic interval.

In operation 712, the administrator 410 may transmit the generated monitoring message to the first SDN controller 420.

In operation 714, the first SDN controller 420 may generate a reply to the received monitoring message.

In operation 716, the first SDN controller 420 may transmit the generated reply to the administrator 410.

In operation 718, the administrator 410 may determine whether the reply is received from the first SDN controller 420.

When the reply is received in operation 718, operation 710 may be re-performed.

When the reply is not received in operation 718, operation 720 may be performed.

In operation 720, the administrator 410 may determine that a failure occurs in the first SDN controller 420 when the reply is not received. The administrator 410 may detect the failure of the first SDN controller 420.

In operations 710 through 720, the first channel 440 that connects the first SDN controller 420 of the SDN and the device 431 may be scanned to verify whether a failure occurs.

In operation 722, the administrator 410 may switch a channel from the first channel 440 to the second channel 450 when a failure is determined to occur in the first SDN controller 420.

In operation 724, the administrator 410 may transmit an activation message to the second SDN controller 430 to activate the second SDN controller 430.

In operation 726, the second SDN controller 430 may be activated based on the activation message. The administrator 410 may activate the second SDN controller 430.

Technical descriptions provided with reference of FIGS. 1 through 6 may be identically applied hereto and thus, a more detailed and repeated description will be omitted here for brevity.

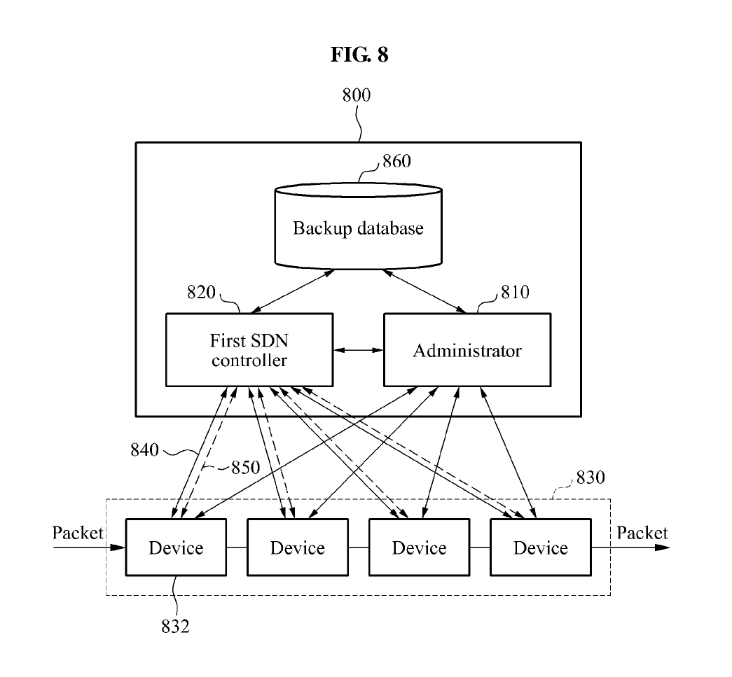

FIG. 8 is a diagram illustrating a configuration of a system for performing network failure restoration using a backup database according to an embodiment of the present invention.

Referring to FIG. 8, the system may include an apparatus 800 for performing network failure restoration and at least one device 830.

The apparatus 800 may include an administrator 810, a first SDN controller 820, and a backup database 860.

The apparatus 800 may additionally include the at least one device 830.

The administrator 810 may perform a function of the backup database 860. The administrator 810 may include the backup database 860. When the administrator 810 to performs the function of the backup database 860, the apparatus 800 may include the administrator 810 and the first SDN controller 820.

The first SDN controller 820 may be an activated SDN controller of SDN.

The system may provide the SDN.

The apparatus 800 may restore a network from a failure occurring in the network. For example, the apparatus 800 may perform functions of the apparatus 200 of FIG. 2. The administrator 810 may correspond to the administrator 210 of FIG. 2. The first SDN controller 820 may correspond to the SDN controller 220 of FIG. 2.

The at least one device 830 may correspond to the at least one device 230 of FIG. 2.

The first SDN controller 820 may be connected to the at least one device 830 through a channel. For example, a first channel 840 may be a channel to connect the first SDN controller 820 and a device 832. An auxiliary channel 850 may be provided for the first channel 840 to connect the first SDN controller 820 and the device 832.

The administrator 810 may be connected to the backup database 860.

The backup database 860 may receive control information on the at least one device from the first SDN controller 820.

When a failure occurs in the connection between the first SDN controller 820 and the device 832, the apparatus 800 may perform network failure restoration using the backup database 860.

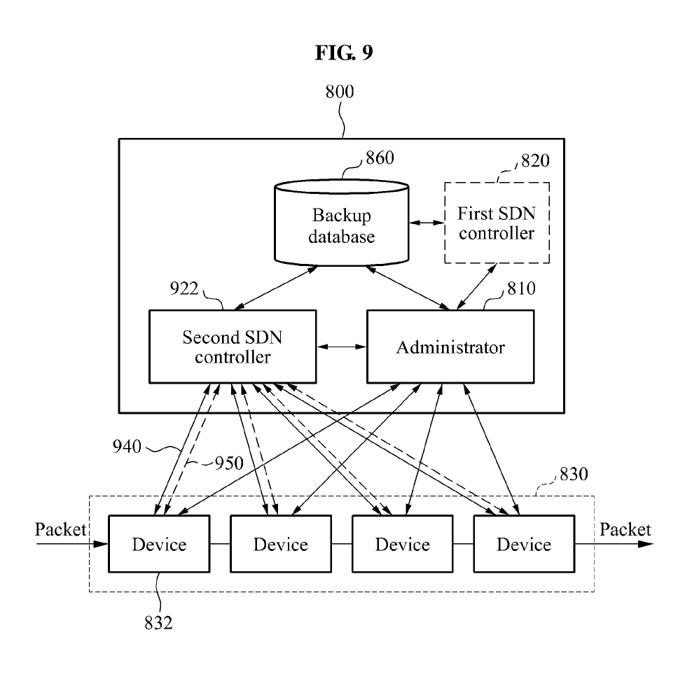

FIG. 9 illustrates a system for performing network failure restoration using the backup database 860 when a failure occurs in the connection between the first SDN controller 820 and the device 832.

Technical descriptions provided with reference to FIGS. 1 through 7 may be identically applied hereto and thus, a more detailed and repeated description will be omitted here for brevity.

FIG. 9 is a diagram illustrating a configuration of a system for performing network to failure restoration using the backup database 860 according to another embodiment of the present invention.

Referring to FIG. 9, a second SDN controller 922 may be an activated SDN controller.

When a failure occurs in the connection between the first SDN controller 820 and the device 832, the apparatus 800 may perform network failure restoration using the backup database 860.

The administrator 810 may restore a network from a failure by changing an activated SDN controller of the SDN from the first SDN controller 820 to the second SDN controller 922. The administrator 810 may set the second SDN controller 922 to change the activated SDN controller from the first SDN controller 820 to the second SDN controller 922.

The second SDN controller 922 may be connected to each of the at least one device 830. For example, a second channel 940 may connect the second SDN controller 922 and the device 832. Also, an auxiliary channel 950 for the second channel 940 may connect the second SDN controller 922 and the device 832.

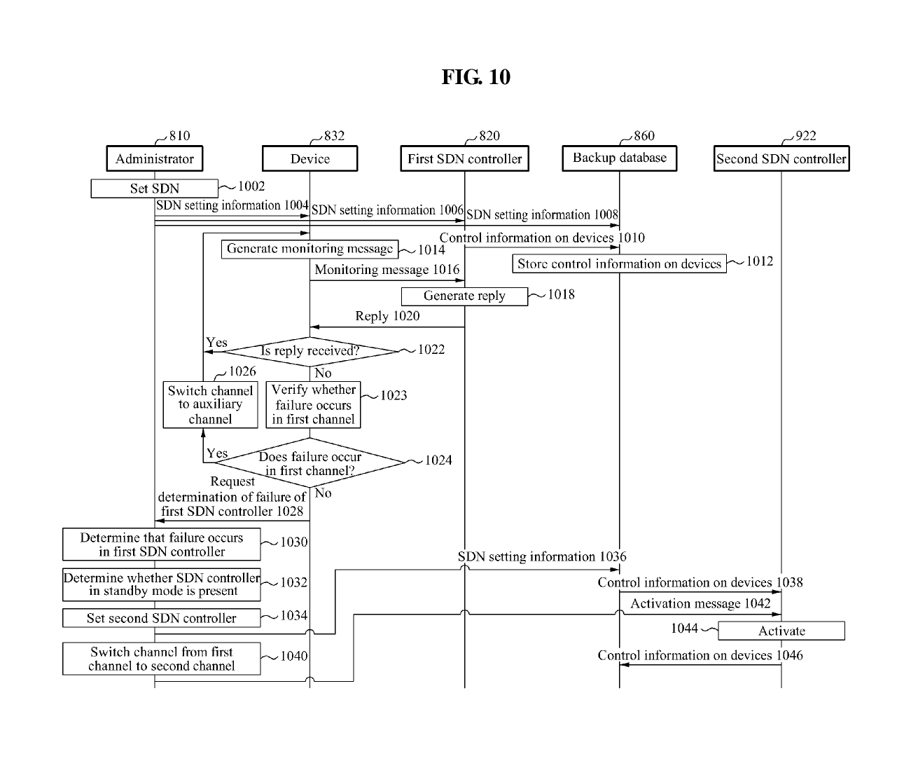

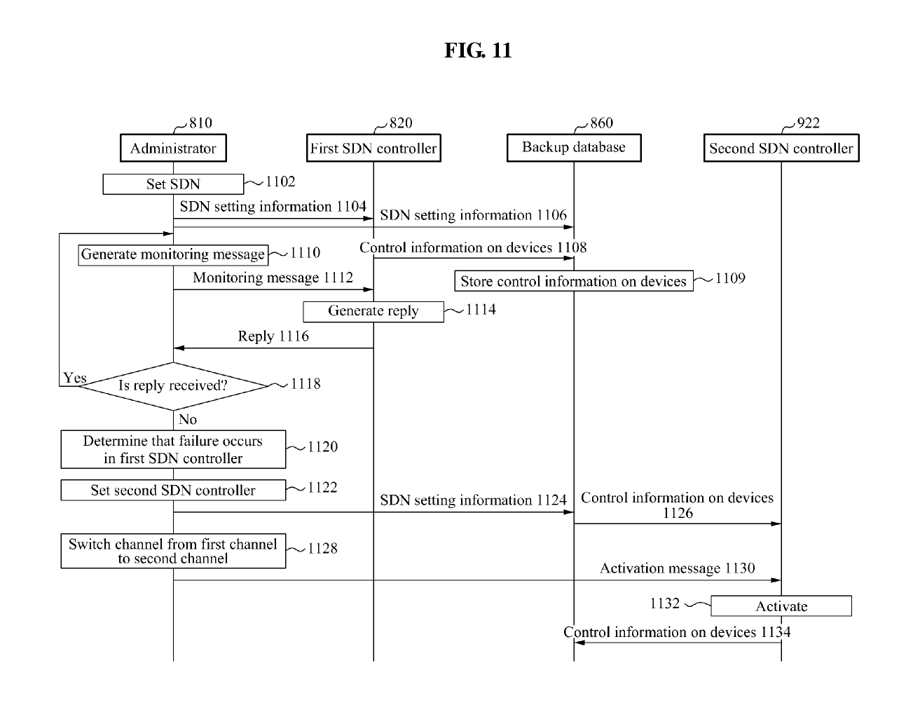

The method of performing network failure restoration using the backup database 860 described with reference to FIGS. 8 and 9 will be further described with reference to FIGS. 10 and 11.

Technical descriptions provided with reference to FIGS. 1 through 8 may be identically applied hereto and thus, a more detailed and repeated description will be omitted here for brevity.

FIG. 10 is a signal flowchart illustrating a method of performing network failure restoration using the backup database 860 according to an embodiment of the present invention.

Operations 1002 through 1006 may correspond to operations 602 through 606 described with reference to FIG. 6, respectively, and thus, respective descriptions of operations 1002 through 1006 may be replaced with descriptions of operations 602 through to 606.

In operation 1008, the administrator 810 may transmit SDN setting information to the backup database 810.

In operation 1010, the first SDN controller 820 may transmit control information on the at least one device 830 to the backup database 860. For example, the first SDN controller 820 may transmit control information on the device 832 to the backup database 860.

In operation 1012, the backup database 860 may store the control information on the at least one device 830. For example, the first SDN controller 820 may store the control information on the device 832.

Operations 1014 through 1032 may correspond to operations 614 through 632 described with reference to FIG. 6, respectively, and thus, respective descriptions of operations 1014 through 1032 may be replaced with descriptions of operations 614 through 632.

In operation 1034, the administrator 810 may set the second SDN controller 922 of the SDN when an SDN controller in a standby mode is not present.

The administrator 810 may set the second SDN controller 922 based on OpenStack cloud technology.

In operation 1036, the administrator 810 may transmit changed SDN setting information to the backup database 860. For example, the changed SDN setting information may include information on the set second SDN controller 922.

In operation 1038, the backup database 860 may transmit the control information on the at least one device 830 to the second SDN controller 922 based on the received SDN setting information.

In operation 1040, the administrator 810 may switch a channel from the first channel 840 to the second channel 940.

The second channel 940 may be a channel to connect the second SDN controller 922 and the device 832.

In operation 1042, the administrator 810 may transmit an activation message to the second SDN controller 922.

Also, the administrator 810 may instruct the at least one device 830 to receive control information from the second SDN controller 922 to be activated.

In operation 1044, the second SDN controller 922 may be activated based on the activation message.

The administrator 810 may activate the second SDN controller 922 based on the activation message.

According to an embodiment, operation 1040 may be performed subsequent to operations 1042 and 1044. For example, in operation 1040, the administrator 810 may switch the channel from the first channel 840 to the second channel 940 when the second SDN controller 922 is activated.

In operation 1046, the activated second SDN controller 922 may transmit the control information on the at least one device 830 to the backup database 860.

Referring to operations 1014 through 1044, the method of performing network failure restoration may be performed by detecting a failure in the connection between the first SDN controller 820 and the device 832 using a monitoring message by the device 832.

Also, the network failure restoration may be performed by detecting a failure in the connection between the first SDN controller 820 and the device 832 using a monitoring message from the administrator 810.

The method of performing network failure restoration by detecting a failure in the connection between the first SDN controller 820 and the device 832 using the monitoring message from the administrator 810 will be further described with reference to FIG. 11.

Technical descriptions provided with reference to FIGS. 1 through 9 may be identically applied hereto and thus, a more detailed and repeated description will be omitted to here for brevity.

FIG. 11 is a signal flowchart illustrating a method of performing network failure restoration by the administrator 810 according to another embodiment of the present invention.

Operations 1102 and 1104 may correspond to operations 602 and 606 described with reference to FIG. 6, respectively.

In operation 1106, the administrator 810 may transmit SDN setting information to the backup database 860.

In operation 1108, the first SDN controller 820 may transmit control information on the at least one device 830 to the backup database 860.

In operation 1109, the backup database 860 may store the received control information on the at least one device 830.

Operations 1110 through 1120 may correspond to operations 710 through 720 described with reference to FIG. 7, respectively, and thus, descriptions of operations 1110 through 1120 may be replaced with descriptions of operations 710 through 720.

Operations 1122 through 1134 may correspond to operations 1034 through 1046 described with reference to FIG. 10, respectively, and thus, respective descriptions of operations 1122 through 1134 may be replaced with descriptions of operations 1034 through 1046.

Technical descriptions provided with reference to FIGS. 1 through 10 may be identically applied hereto and thus, a more detailed and repeated description will be omitted here for brevity.

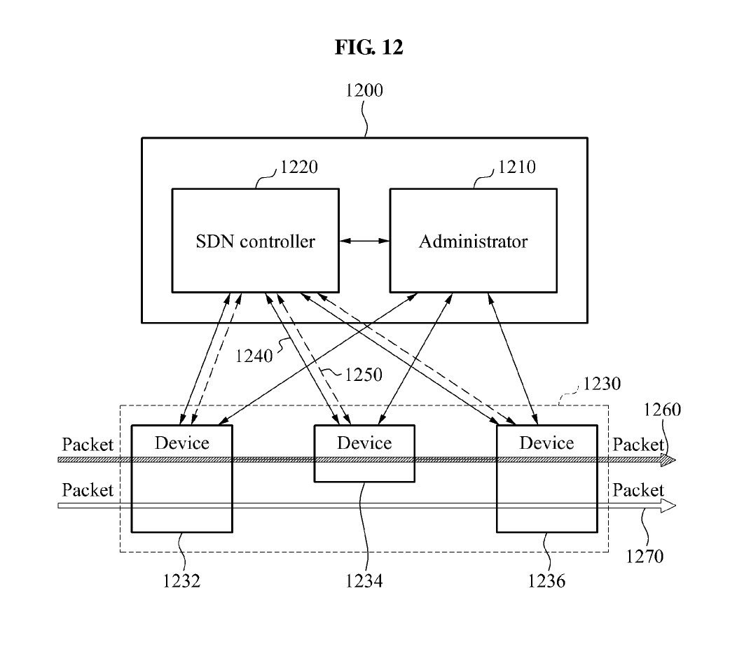

FIG. 12 is a diagram illustrating a configuration of a system for performing network failure restoration by changing a path through which a packet is transmitted according to an embodiment of the present invention.

Referring to FIG. 12, the system may include an apparatus 1200 for performing network failure restoration and at least one device 1230.

The apparatus 1200 may include an administrator 1210 and an SDN controller 1220.

The apparatus 1200 may additionally include the at least one device 1230.

The apparatus 1200 may correspond to the apparatus 200 of FIG. 2. The administrator 1210 may correspond to the administrator 210 of FIG. 2, and the SDN controller 1220 may correspond to the SDN controller 220 of FIG. 2.

The at least one device 1230 may correspond to the at least one device 230 of FIG. 2. A first channel 1240 may correspond to the first channel 240 of FIG. 2, and a second channel 1250 may correspond to the second channel 250 of FIG. 2.

The SDN controller 1220 may set a first path 1260 using at least one among the at least one device 1230 to transmit a packet.

A device 1232, a device 1236, and a device 1234 of the at least one device 1230 may be in an ingress node, an egress node, and an intermediate node, respectively.

For example, when a failure is detected in the device 1234, the apparatus 1200 may set a second path 1270 using devices without the device 1234 in which the failure is detected among the at least one device 1230 to transmit a packet.

When a failure occurs in the device 1234 which is the intermediate node, not in the device 1232 which is the ingress node of the first path 1260 and the device 1236 which is the egress node of the first path 1260, the second path 1270 may be set to bypass the device 1234.

The apparatus 1200 may perform network failure restoration using the second path 1270. The apparatus 1200 may transmit a packet using the second path 1270.

The second path 1270 may be a path using the device 1232 and the device 1236 among the at least one device 1230.

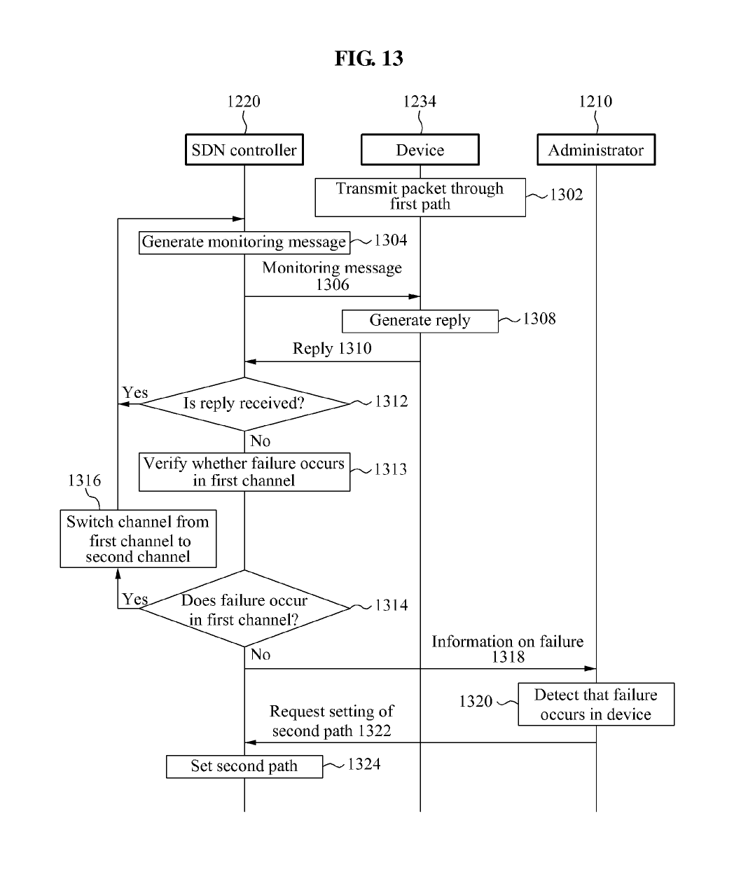

A method of performing network failure restoration by detecting a failure of the device 1234 will be further described with reference to FIG. 13.

Technical descriptions provided with reference to FIGS. 1 through 11 may be identically applied hereto and thus, a more detailed and repeated description will be omitted for brevity.

FIG. 13 is a signal flowchart illustrating a method of performing network failure restoration by changing a path through which a packet is transmitted according to an embodiment of the present invention

Operations 1302 through 1324 may be performed subsequent to operation 306 described with reference to FIG. 3.

In operation 1302, the device 1234 may transmit a packet through the first path 1260 set by the SDN controller 1220 to transmit the packet.

In operation 1304, the SDN controller 1220 may generate a monitoring message to detect a failure in the connection between the SDN controller 1220 and the device 1234. The SDN controller 1220 may generate the monitoring message at a predetermined periodic interval.

In operation 1306, the SDN controller 1220 may transmit the generated monitoring message to the device 1234 through the first channel 1240.

In operation 1308, the device 1234 may generate a reply to the received monitoring message.

For example, the reply may include at least one of information on a point in time at which the monitoring message is received, information on a point in time at which the reply is generated, and information on the first channel 1240.

In operation 1310, the device 1234 may transmit the generated reply to the SDN controller 1220 through the first channel 1240.

In operation 1312, the SDN controller 1220 may determine whether the reply is received from the device 1234.

For example, when the reply is not received within a predetermined period of time from a point in time at which the monitoring message is transmitted, the SDN controller 1220 may determine that the reply is not received.

When the SDN controller 1220 receives the reply from the device 1234 in response to the monitoring message in operation 1312, operation 1304 may be re-performed.

When the SDN controller 1220 does not receive the reply from the device 1234 in response to the monitoring message in operation 1312, operation 1314 may be re-performed.

In operation 1314, the SDN controller 1220 may determine whether a failure occurs in the first channel 1240.

For example, the SDN controller 1220 may determine whether a failure occurs in the first channel 1240 by transmitting the monitoring message through the second channel 1250.

When the reply is not received from the device 1234 after the monitoring message is transmitted through the second channel 1250, the SDN controller 1220 may determine that a failure occurs in the device 1234.

When the reply is received from the device 1234 after the monitoring message is transmitted through the second channel 1250, the SDN controller 1220 may determine that a failure occurs in the first channel 1240.

When the failure occurs in the first channel 1240 in operation 1314, operation 1316 may be performed.

When the failure does not occur in the first channel 1240 in operation 1314, operation 1318 may be performed.

When the failure does not occur in the first channel 1240 in operation 1314, operations 1318 through 1322 may not be performed, but operation 1324 may be performed. In operation 1316, the SDN controller 1220 may switch a channel from the first channel 1240 to the second channel 1250.

Operation 1304 may be re-performed subsequent to operation 1316.

In operation 1318, the SDN controller 1220 may transmit information on the failure to the administrator 1210 when the failure does not occur in the first channel 1240.

In operation 1320, the administrator 1210 may detect the failure occurring in the device 1234.

For example, the administrator 1210 may detect the failure of the device 1234 through a channel connected between the administrator 1210 and the device 1234.

In operation 1322, the administrator 1210 may request the SDN controller 1220 to set the second path 1270.

In operation 1324, the SDN controller 1220 may set the second path 1270 using the devices without the device 1234 in which a failure is detected among the at least one device 1230 to transmit a packet.

For example, the SDN controller 1220 may set the second path 1270 based on the request for the setting of the second path 1270.

The packet may be transmitted through the second path 1270.

Technical descriptions provided with reference to FIGS. 1 through 12 may be identically applied hereto and thus, a more detailed and repeated description will be omitted here for brevity.

According to embodiments of the present invention, there is provided a method and an apparatus for network failure restoration.

According to embodiments of the present invention, there is provided a method and an apparatus for network failure restoration in a software-defined networking (SDN) network.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially to configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of performing network failure restoration, the method comprising:
verifying whether a failure occurs in a first channel connecting a first software-defined networking (SDN) controller of SDN and a device; and
switching a channel from the first channel to a second channel when the failure is detected by the verifying,
wherein the first SDN controller sets a path through which a packet is transmitted through at least one device comprising the device in an SDN network.

2. The method of claim 1, wherein the second channel is an auxiliary channel to connect the first SDN controller and the device.

3. The method of claim 2, further comprising:
transmitting control information on the at least one device from the first SDN controller to a second SDN controller of the SDN,
wherein the control information is information on the at least one device used to set the path.

4. The method of claim 2, wherein the verifying comprises:
receiving a monitoring message from the device through the first channel,
wherein, when the device does not receive a reply to the monitoring message, the verifying comprises detecting a failure of the first channel, and
wherein, when the failure of the first channel is detected, the switching of the channel is performed by the device.

5. The method of claim 4, further comprising:
receiving, by an administrator, information on the switching of the channel from the device when the switching of the channel is performed, wherein the administrator is connected to the first SDN controller and the device; and
setting, by the administrator, a third channel to connect the first SDN controller and the device,
wherein, when a failure of the second channel is detected, the third channel is used to recover from the failure of the second channel.

6. The method of claim 1, further comprising:
transmitting control information on the at least one device from the first SDN controller to a second SDN controller of the SDN,
wherein the second channel is a channel to connect the second SDN controller and the device, and
wherein the control information is information on the at least one device used to set the path.

7. The method of claim 6, wherein the verifying comprises:
receiving a monitoring message from the device through the first channel; and
determining whether a failure occurs in the first channel when the device does not receive a reply to the monitoring message,
wherein, when a failure does not occur in the first channel, the switching of the channel is performed.

8. The method of claim 7, wherein the switching of the channel comprises:
determining, by the administrator, whether an SDN controller of the SDN in a standby mode is present; and
activating, by the administrator, the second SDN controller when the second SDN controller is in the standby mode,
wherein the administrator is connected to the first SDN controller, the second SDN controller, and the device.

9. The method of claim 7, wherein the verifying further comprises:
determining, by the administrator, that a failure occurs in the first SDN controller when a failure is not detected in the first channel and failure messages are received by the administrator from at least two among the at least one device,
wherein the administrator is connected to the first SDN controller, the second SDN controller, and each of the at least one device.

10. The method of claim 6, wherein the verifying comprises:
transmitting a monitoring message from the administrator to the first SDN controller; and
determining that a failure occurs in the first SDN controller when the administrator does not receive a reply to the monitoring message from the first SDN controller,
wherein, when a failure is determined to occur in the first SDN controller, the switching of the channel is performed, and
wherein the administrator is connected to the first SDN controller, the second SDN controller, and each of the at least one device.

11. The method of claim 1, further comprising:
transmitting control information on the at least one device from the first SDN controller to a backup database; and
storing the control information in the backup database,
wherein the control information is information on the at least one device used to set the path.

12. The method of claim 11, further comprising:
transmitting the control information from the backup database to the second SDN controller of the SDN when a failure is detected,
wherein the second channel is a channel to connect the second SDN controller and the device.

13. The method of claim 11, wherein the verifying comprises:
receiving a monitoring message from the device through the first channel; and
determining whether a failure occurs in the first channel when the device does not receive a reply to the monitoring message.

14. The method of claim 13, wherein the switching of the channel comprises:
switching the channel from the first channel to the second channel that is the auxiliary channel to connect the first SDN controller and the device when a failure is detected in the first channel.

15. The method of claim 13, wherein the verifying further comprises:
determining, by the administrator, that a failure occurs in the first SDN controller when a failure is not detected in the first channel and failure messages are received from at least two among the at least one device,
wherein the administrator is connected to the first SDN controller, the backup database, and each of the at least one device.

16. The method of claim 15, wherein the switching of the channel comprises:
setting, by the administrator, the second SDN controller of the SDN;
transmitting the control information from the backup database to the second SDN controller; and
activating, by the administrator, the second SDN controller,
wherein the second channel is a channel to connect the second SDN controller and the device, and
wherein, when the second SDN controller is activated, the switching of the channel is performed.

17. The method of claim 11, wherein the verifying comprises:
transmitting a monitoring message from an administrator to the first SDN controller; and
determining that a failure occurs in the first SDN controller when the administrator does not receive a reply to the monitoring message from the first SDN controller,
wherein the switching of the channel comprises:
setting, by the administrator, a second SDN controller of the SDN;
transmitting the control information from the backup database to the second SDN controller; and
activating, by the administrator, the second SDN controller,
wherein the second channel is a channel to connect the second SDN controller and the device, and
wherein, when the second SDN controller is activated, the switching of the channel is performed.

18. An apparatus for performing network failure restoration, the apparatus comprising:
a first software defined networking (SDN) controller to set a path through which a packet is transmitted using at least one device to transmit the packet in an SDN network; and
an administrator to set the first SDN controller of the SDN and the at least one device, −wherein the first SDN controller is connected to a device through a first channel, −wherein, when a failure is detected in the connection between the first SDN controller and the device, a channel is switched from the first channel to a second channel, and −wherein the at least one device comprising the device transmits the packet through the set path.

19. A method of performing network failure restoration, the method comprising:
transmitting a monitoring message from a software defined networking (SDN) controller of SDN to a device through a first channel connecting the SDN controller and the device, wherein at least one device comprising the device transmits a packet through a first path set by the SDN controller to transmit the packet;
determining whether a failure occurs in the first channel when the SDN controller does not receive a reply to the monitoring message from the device; and
setting a second path to provide a detour around the device to transmit the packet by the SDN controller when a failure does not occur in the first channel, −wherein the packet is transmitted through the second path.

20. The method of claim 19, further comprising:
transmitting information on a failure from the SDN controller to an administrator when a failure does not occur in the first channel;
detecting, by the administrator, the failure occurring in the device; and
requesting, by the administrator, the SDN controller to set the second path, −wherein the setting of the second path is performed by the SDN controller based on the requesting, and −wherein the administrator is connected to the first SDN controller and each of the at least one device.
